(19) United States
(12) Patent Application Publication
(10) Pub. No.: US 2007/0277602 A1
(43) Pub. Date: Dec. 6, 2007

(54) Tire Pressure Monitoring Device For A Motor Vehicle

(75) Inventors: Andreas Heise, Erzhausen (DE); Artur Otto, New-Anspach (DE); Jens Bachon, Niedernhausen (DE); Ralf Hartmann, Kriftel (DE)

Correspondence Address: Craig Hallacher;Continental Teves, One Continental Drive, Auburn Hills, MI, 48326, US

(73) Assignee: COntinental Teves AG & Co. oHG

(21) Appl. No.: 10/589,304

(22) PCT Filed: Feb. 11, 2005
(86) PCT No.: PCT/EP05/50613

§ 371 Date: Jun. 19, 2007

(30) Foreign Application Priority Data
Feb. 12, 2004 (DE) 10 2004 007 136.5

(51) Int. Cl. B60C 23/04

(52) U.S. Cl. 73/146.5

(57) ABSTRACT

Disclosed is a tire pressure-monitoring device for a motor vehicle, having at least one control unit (6) and/or at least one central box (10) being connected to the wheel house transceivers (4) arranged in the area of the wheel houses by way of wheel speed sensor and control conduits (5) or by way of wheel speed sensor conduits (11) and actuating conduits (13), which transceivers are appropriate for the wireless unidirectional or bidirectional transmission of information and energy to a transponder (1) arranged in the wheel or tire proximate the wheel house.

### BACKGROUND OF THE INVENTION

The present invention relates to a tire pressure-monitoring device for a motor vehicle equipped with transponders (1) which are arranged in or at the wheels or tires and communicate with respectively one associated wheel house transceiver (4) by means of a wireless unidirectional or bidirectional information and energy transmission.

It is of great significance for vehicle safety to reliably monitor the tire pressure on all wheels of a motor vehicle or a motorcycle. There are different approaches how to realize tire pressure-monitoring systems. So-called tire pressure-monitoring systems with direct pressure measurement exist, which determine the tire inflation pressure directly in the wheels and transmit it to an electronic evaluating unit using transmitting and receiving devices. A directly measuring tire pressure-monitoring system of this type is e.g. disclosed in DE 199 38 431 C2. Usually, the tire inflation pressure is detected by means of a battery-powered pressure module, and is sent to one or more receiving modules using radio transmission. A major drawback of these prior art systems involves that the useful life of the pressure module is greatly restricted by the use of a battery, and that the environmental acceptability is impaired by contaminants in the batteries. It is furthermore disadvantageous that generally a great complexity in electronics is needed when allocating the individual pressure modules to certain installation positions (e.g. left front wheel, right front wheel, etc.) is desired. DE 199 26 616 C2 e.g. discloses a method for implementing an allocation of tire pressure checking devices.

Another possibility of monitoring the tire inflation pressure involves attaching a battery-less transponder in or to the tire, which is supplied with energy externally, for example, by means of radio waves. This transponder detects the tire inflation pressure and sends it for further processing to an evaluating unit. DE 199 24 830 A1 e.g. discloses a device for measuring pressure and temperature in motor vehicle tires and for monitoring the wear, which comprises a transponder for detecting the tire inflation pressure. Another tire pressure-monitoring system with a transponder is known from EP 0 832 765 B1. A method of monitoring the condition of a tire by means of a transponder is further disclosed in U.S. Pat. No. 6,400,261 B1. In addition, a device for monitoring and identifying pneumatic tires is described in EP 1 354 729 A1.

In view of the above, an object of the invention is to provide a tire pressure-monitoring device, which is able to detect and allocate, in a reliable and low-cost fashion, pressure loss on several tires of a motor vehicle or a motorcycle.

### SUMMARY OF THE INVENTION

This object is achieved according to the invention by a tire pressure-monitoring device for a motor vehicle equipped with transponders (1) which are arranged in or at the wheels or tires and communicate with respectively one associated wheel house transceiver (4) by means of a wireless unidirectional or bidirectional information and energy transmission. The tire pressure-monitoring device has at least one control unit (6) and/or at least one central box (10) being connected to the wheel house transceivers (4) arranged in the area of the wheel houses by way of wheel speed sensor and control conduits (5), or wheel speed sensor conduits (11) and actuating conduits (13).

In a favorable embodiment, a wheel house transceiver is arranged proximate each wheel, most preferably in each wheel house of the vehicle, said transceiver corresponding with a transponder and being connected to a wheel rotational speed sensor.

Favorably, all wheel house transceivers are connected to one single control unit and/or one single central box by way of conduits of wheel speed sensors and control conduits.

In another preferred embodiment, data between the wheel house transceivers and the transponder is sent and received only in a defined angular range of the wheel, the so-called range of transmission A.

The printed circuit board of a transmitting antenna is connected to a cable harness of the vehicle, preferably by means of press-in contacts.

In another preferred embodiment, data of the transponder is sent only after a sufficient amount of energy has been collected during several wheel rotations by means of an intermediate store arranged in the transponder.

Advantageously, the transmitting frequency of the wheel house transceiver is in the range of roughly 0.8 kilohertz to roughly 800 kilohertz, most preferably in the range of roughly 70 kilohertz up to roughly 200 kilohertz.

The transmitting frequency of the transponder is preferably in the range of roughly 0.8 megahertz to roughly 800 megahertz, most preferably in the range of roughly 5 megahertz up to roughly 100 megahertz.

The transmitting frequency of the transponder is modulated for data transmission in another advantageous embodiment.

The data transmission from the wheel house transceivers to the control unit or the central box, respectively, preferably takes place through the conduits of the wheel speed sensor already provided in the vehicle.

In a particularly favorable fashion, likewise the data from the control unit or the central box, respectively, is transmitted to the wheel house transceivers or the transponders, respectively, through the conduits of the wheel speed sensor.

It is furthermore preferred to modulate the data of the wheel house transceiver being transmitted onto the data of the wheel speed sensors.

Favorably, the control unit is integrated into a brake control unit (ECU) of the motor vehicle.

### BRIEF DESCRIPTION OF THE DRAWINGS

Further preferred embodiments can be seen in the sub claims. The invention will be described by way of the Figures in the following. In the drawings:

FIG. 1 is a view of a tire pressure-monitoring system of the invention;

FIG. 2 is a view of the installed transponder;

FIG. 3 shows a second embodiment of the tire pressure-monitoring system of the invention;

FIG. 4 shows a third embodiment of the tire pressure-monitoring system of the invention;

FIG. 5 shows possible arrangements of transmitting antennas and transponders at the vehicle wheel; and

FIG. 6 shows the design of a transmitting antenna of the invention.

### DETAILED DESCRIPTION OF THE DRAWINGS

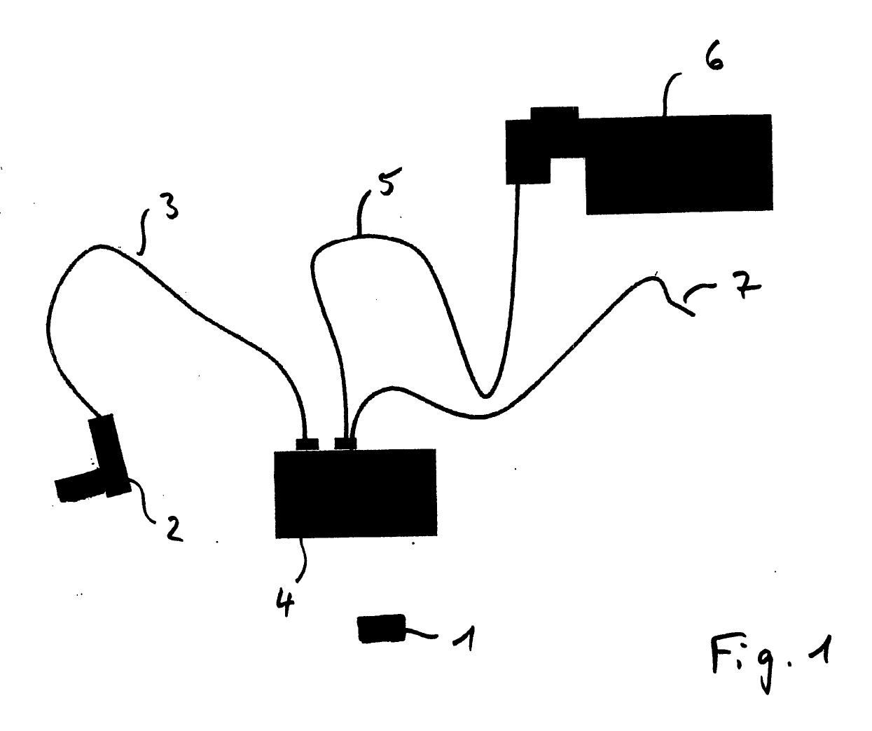

FIG. 1 shows an overview of the tire pressure-monitoring system of the invention. A transponder 1 transmits tire information and/or other data to a wheel house transceiver 4 and receives energy and/or data signals from the wheel house transceiver 4. The wheel house transceiver 4 receives further data from a wheel speed sensor 2 through a wheel speed sensor conduit 3. The wheel house transceiver 4 is supplied with energy through a supply conduit 7 and exchanges data with the control unit 6 through a wheel speed sensor conduit and control conduit 5. FIG. 1 illustrates in this respect only the connection of a wheel house transceiver 4 to the control unit 6. According to the invention, a wheel house transceiver 4 is arranged proximate each wheel, e.g. in each wheel house of the vehicle, said transceiver corresponding with a transponder 1 and being connected to a wheel speed sensor 2. All wheel house transceivers 4 are connected to one single control unit 6 by way of wheel speed sensor and control conduits 5. A tire pressure-monitoring system of the invention intended for use in a four-wheel vehicle thus includes a control unit 6, four wheel house transceivers 4 connected to the control unit 6, four transponders 1, and four wheel speed sensors 2 connected to the wheel house transceivers 4.

A tire pressure-monitoring system of the invention intended for use in a two-wheel vehicle thus includes a control unit 6, two wheel house transceivers 4 connected to the control unit 6, two transponders 1, and two wheel speed sensors 2 connected to the wheel house transceivers 4. In motorcycles, the wheel house transceivers 4 are arranged at the inside surfaces of the fenders. If this is not possible, e.g. as regards enduro motorcycles (enduros) due to the large distance between the fenders and the tires, as a result of which the distance of transmission between wheel house transceiver 4 and transponder 1 would become too large, the wheel house transceivers 4 can also be arranged at other appropriate locations such as the stanchions.

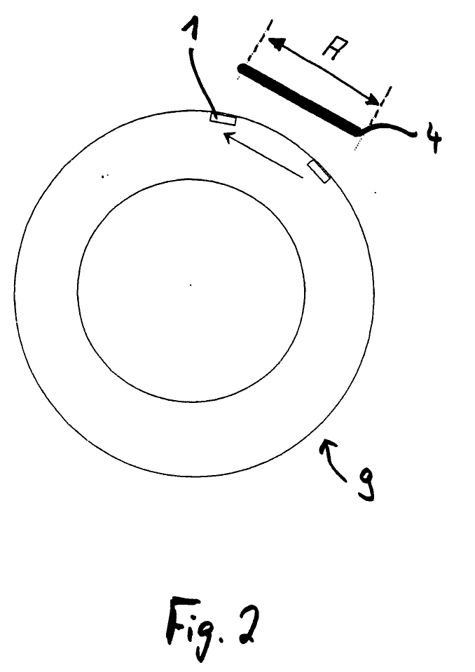

FIG. 2 illustrates a wheel 9 of a vehicle, its interior housing the transponder 1. The wheel house transceiver 4 is arranged above the wheel. Data from and to the transponder 1 can only be transmitted and received in a defined angular range of the wheel, the so-called range of transmission A.

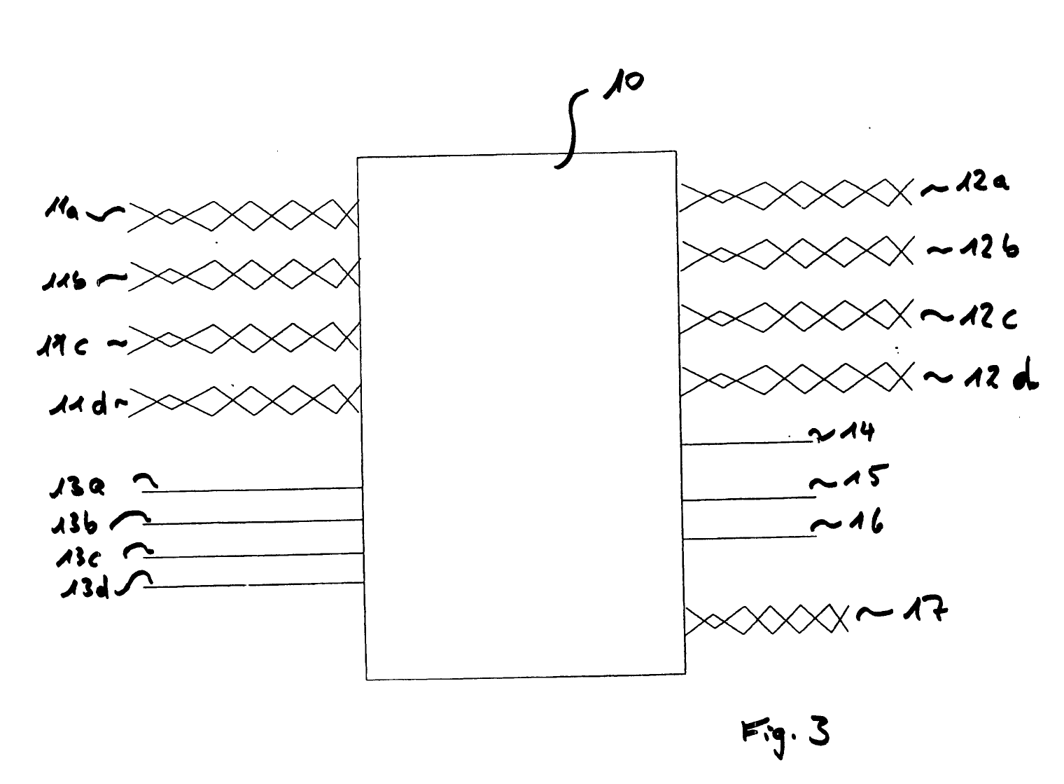

A second embodiment of the tire pressure-monitoring system of the invention is shown in FIG. 3. In this arrangement, the wheel house transceivers 4 are not connected directly to the control unit 6 like in FIG. 1. Rather, a central box 10 is arranged intermediate the wheel speed sensor conduits 11a-11d and 12a-12d. Further, the central box 10 is connected to non-illustrated wheel house transceivers 4 by way of actuation conduits 13a-13d. The central box 10 is supplied with energy through the ports 14, 15, 16. Through a data conduit 17, the central box 10 can exchange data with a vehicle data bus (CAN, LIN, etc.) or other systems.

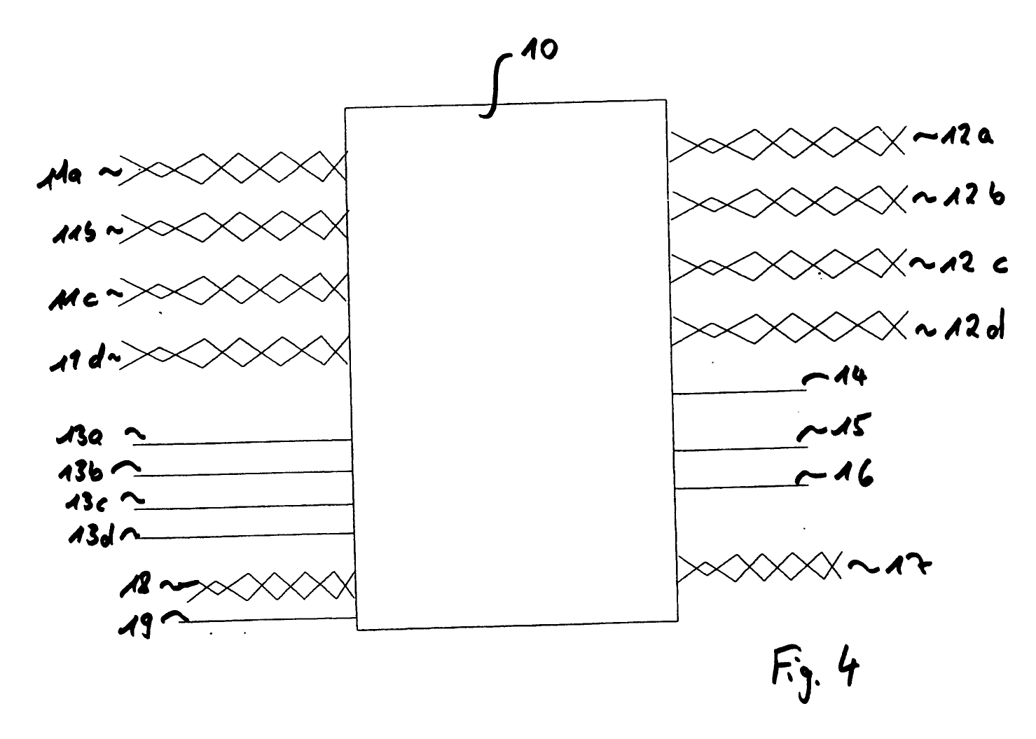

FIG. 4 illustrates a third embodiment of the tire pressure-monitoring system of the invention. The tire pressure-monitoring system known from FIG. 3 is supplemented to such effect that an additional transponder antenna, which e.g. corresponds with another transponder in an ignition key, can be connected at the central box 10, to a connecting conduit 18. This additional transponder antenna can be actuated by way of an additional actuating conduit 19. This renders it possible, for example, to deactivate an immobilizer when the transponder in the ignition key is identified as belonging to the vehicle.

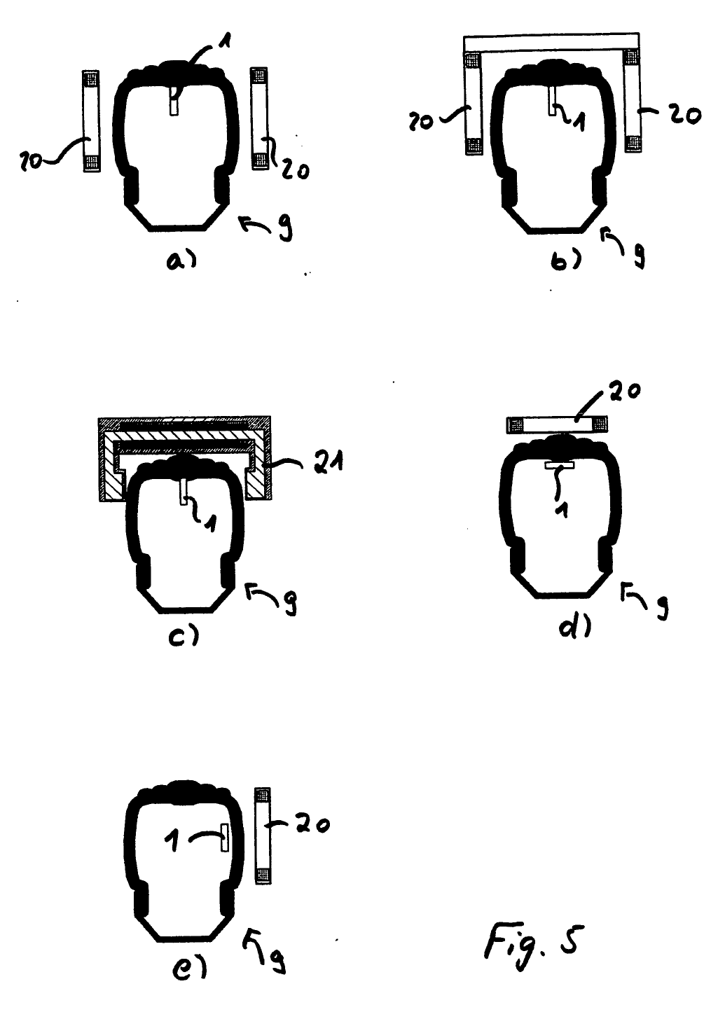

FIG. 5 illustrates possible arrangements of transmitting antennas 20, 21 and transponders 1 at the vehicle wheel 9. The transmitting antennas 20, 21 can be components, which are adapted to be connected to the transceivers 4, or the transmitting antennas 20, 21 are structurally united with the transceivers 4. The transmitting antennas 20, 21 are basically composed of coils without ferrite filling (transmitting antennas 20) or of coils that have a filling (transmitting antenna 21), for example, a ferrite core for optimizing the magnetic circuit. It is of course possible to substitute coils with a ferrite core for the magnetic circuit optimization, as shown in FIG. 5c, for the coils without ferrite filling as illustrated in FIGS. 5a, 5b, 5d, 5e. FIG. 5a shows a wheel 9 having two laterally arranged transmitting antennas 20 and a vertical transponder 1. This arrangement is very well suited for motorcycles, in particular for enduro motorcycles, in which it is not possible to mount the transmitting antennas 20 or the transceivers 4, respectively, at the inside surfaces of the fenders. Besides, the arrangement according to FIG. 5a is advantageous because a stronger field (electric or magnetic field) develops due to the two coils at a reduced current strength or a smaller number of windings of the coil, respectively. FIG. 5b shows a similar arrangement like FIG. 5a, yet only the transmitting antennas 20 are arranged in a joint housing. FIG. 5c like 5b includes two coils in a joint housing, and the coils include a ferrite core for the optimization of the magnetic circuit in this case. FIG. 5d illustrates the arrangement of the transmitting antenna 20 in relation to the transponder 4, which is preferred for use in passenger cars and trucks. FIG. 5e shows a lateral arrangement of the transmitting antenna 20 in relation to the wheel and a transponder 1 arranged at the tire sidewall. Especially in vehicles with large spring travels, e.g. enduro motorcycles or off-road vehicles, only the lateral arrangement of the transmitting antenna(s) 20 allows a transmission between transponder 1 and transceiver 4, which would not be possible in an arrangement according to FIG. 5d on account of the too large distances between transponder 1 and transceiver 4.

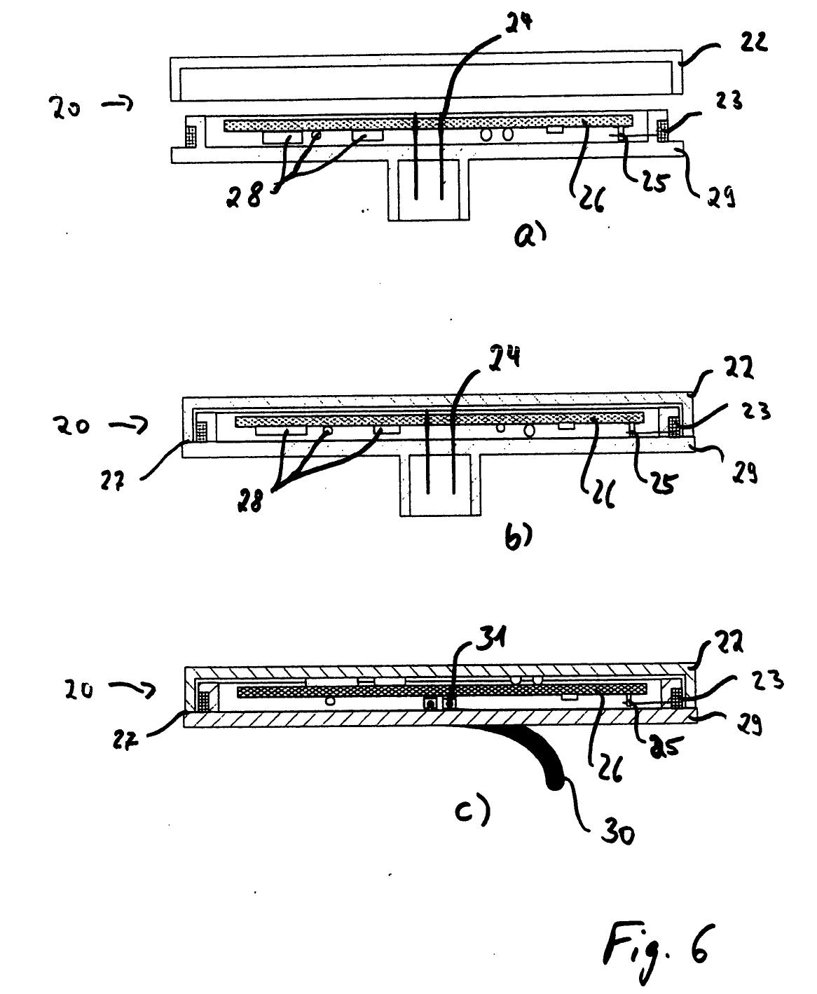

FIG. 6 shows the design of a transmitting antenna 20 of the invention. FIG. 6a depicts a housing bottom part 29 with a printed circuit board 26, on which several components 28 are arranged, herein SMD components. The connection between the printed circuit board 26 and a non-illustrated cable harness of the vehicle is provided e.g. using press-in contacts 24. Other connection techniques such as soldered plug contacts, etc., are of course also possible. A coil 23 is connected to the printed circuit board 26 by means of insulation displacement contacts 25. Above the housing bottom part 29, there is a housing top part 22, which (like illustrated in FIG. 6b) is connected to the housing bottom part 29 by means of a friction welding process, illustrated by a friction welding contact point 27. Beside a friction welding process, other methods such as screw coupling or adhesion are feasible to connect the housing bottom part 29 to the housing top part 22. FIG. 6c shows a variation of a transmitting antenna 20, wherein instead of a plug contact there is a direct contacting of a cable outlet 30 to the printed circuit board 26 using insulation displacement contacts 31. In this context, the coils 23 can include either a material filling, e.g. a ferrite filling, or they may have no ferrite filling. The components 28 are used to amplify signals. As the electric or magnetic field of a coil is actually never aligned optimally, further coils can be employed to ‘guide’ the field. The field configuration of a coil can be influenced by a coil having a different field, which has an identical or an inverse field configuration. As a result, the field of the coil can be directed to the transponder 1, whereby the efficiency is enhanced.

In a vehicle equipped with an electronic brake system (EBS) such as an anti-lock system (ABS) or an electronic stability system (ESP), wheel speed sensors 2 to detect rotational wheel speeds are already provided and connected to a brake control unit by way of connecting conduits. These wheel speed sensors 2 and partly also the connecting conduits are used by the tire pressure-monitoring system of the invention. In the tire pressure-monitoring system of the invention, a wheel house transceiver 4 is mounted proximate each wheel and is in connection to the wheel speed sensor 2 disposed on this wheel and to the control unit 6 or a central box 10. Further, there is a wireless connection between the wheel house transceiver 4 and a transponder 1 in or at a tire, in the vicinity whereof, e.g. in the wheel house, the wheel house transceiver 4 is placed. The wheel house transceiver 4 basically comprises a transmitting antenna 20, 21 with an electronic actuating unit that transmits energy to the transponder 1. Further, the transmitting antenna 20, 21 is able to transmit also data into the transponder 1. The wheel house transceiver 4 additionally comprises a receiving antenna to receive any data emitted by the transponder 1 as well as an amplification circuit for amplifying the data received. The transmitting and receiving antennas work in different frequency ranges herein. The transmitting frequency of the transponder 1 is expediently designed in such a fashion that only low transmitting energy is necessary. On the other hand, the transmitting frequency of the wheel house transceiver 4 must be rated such that even at rapid speed of the vehicle, a sufficient amount of energy can be transmitted in the short range of transmission A from the wheel house transceiver 4 to the transponder 1, enabling the transponder 1 to emit information about the tires. It is also possible for the transponder 1 to collect a sufficient amount of energy (intermediate store) over several wheel rotations and to emit the data at the appropriate point of time only after sufficient energy exists. In addition, the frequencies used should comply with the regulations about freely usable frequency ranges being customary in the respective country. Appropriate frequencies e.g. lie in the HF or MF range. A frequency in the range of roughly 0.8 kilohertz up to roughly 800 kilohertz, in particular roughly 70 kilohertz to roughly 200 kilohertz, is appropriate for the transmitting frequency of the wheel house transceiver 4. A frequency in the range of roughly 0.8 megahertz up to roughly 800 megahertz, in particular roughly 5 megahertz up to roughly 100 megahertz is appropriate for the transmitting frequency of the transponder 1. Previous transponder-receiver systems are mostly rated only for short distances of transmission (about 30 cm distance between transponder and receiver). The separation of the receiving unit in a control unit 6 or a central box 10, respectively, and several wheel house transceivers 4 allows the tire pressure-monitoring system of the invention to extend this small distance of transmission to some meters. The transponder 1 transmits and receives data or energy by way of the wheel house transceivers 4 arranged in the direct neighborhood of the transponder 1. The wheel house transceivers 4 receive control signals from the remote control unit 6 or the remote central box 10, respectively. For data transmission into the transponder 1, a modulation is advisable, e.g. an amplitude modulation (ASK), a frequency modulation (FSK), or a phase modulation (PSK) of the transmitting frequency. In the (analog) amplitude modulation (ASK), (digital) data is transmitted in that the signal amplitude between standard capacity (corresponds to the digital ‘1’) and zero capacity (corresponds to the digital ‘0’) is switched to and fro, with the result that it is rendered possible to transmit digital signals in spite of the actually analog data transmission.

Data transmission from the wheel house transceivers 4 to the control unit 6 or the central box 10, respectively, in this case occurs through the wheel speed sensor conduits 3, 11 provided in the vehicle. As this occurs, the data of the wheel house transceiver 4 being transmitted is modulated onto the data of the wheel speed sensors 2. It is likewise possible to transmit data from the control unit 6 or the central box 10, respectively, through the wheel speed sensor conduits 3, 11 to the wheel house transceivers 4 or the transponders 1, respectively.

The control unit 6 can be integrated into a brake control unit (ECU), for example. If this integration is not possible, a central box 10 is used, which assumes the tasks of the control unit. The central box 10 is connected between the wheel speed sensor conduits 11, 13. The central box 10 conveys the data received through the wheel speed sensor conduits 11 and evaluated to a vehicle data bus (e.g. CAN, LIN, etc.) for further processing, display, or evaluation. This data can also be conveyed in a per se known manner in the form of digital signals. If, for example, tire inflation pressure loss prevails, this fact can be reported to the driver and, optionally, to further vehicle systems.

Control signals are transmitted from the control unit 6 of the central box 10 to the wheel house transceivers 4 in order to determine tire pressure. The wheel house transceivers 4 send energy signals and/or data signals to the associated transponders 1. The energy and/or data signals of the wheel house transceivers 4 are received and/or converted by the associated transponders 1. After a sufficient amount of energy has been received, the transponders 1 detect tire information with the aid of sensors, such as the tire inflation pressure or the tire temperature, and subsequently emit this tire information using a transmitting device arranged in the transponder 1. The emitted tire information is received by receiving antennas arranged in the associated transceivers 4 or connectable to the transceivers 4. The received tire information is conducted to the control unit 6 or the central box 10, optionally in an amplified manner. Subsequently, tire information is evaluated in the control unit 6 or the central box 10 and indicated to the driver in general, or only in the event of a tire defect.

Control signals for actuating the wheel house transceivers 4 can be transmitted either simultaneously or consecutively. When the wheel house transceivers 4 are actuated simultaneously, what means that all wheel house transceivers 4 perform an energy transfer to the transponders 1 respectively allocated to them, the transponders 1 will transmit the tire information to the wheel house transceivers 4, as soon as they have sufficient energy to transmit tire information (tire pressure, temperature, etc.). The wheel house transceivers 4 amplify the tire information received from the transponders 1 and send it to the control unit 6 or the central box 10, respectively. As a result, tire information is available as quickly as possible, e.g. already when the vehicle starts, and can be evaluated in view of a possible tire inflation pressure loss. This action can take place either for all wheels or only for the front wheels or only the rear wheels. An allocation of the received tire information to an installation position is herein not possible without additional information such as in the form of tire identification codes (identifier), which are sent along with the tire information.

If, in contrast thereto, the wheel house transceivers 4 are actuated separately, an allocation of the received tire information to an installation position is possible. To this end, it must be known to the control unit 6 or the central box 10, respectively, at which installation position a wheel house transceiver 4 is arranged. It is also possible to actuate e.g. all wheel house receivers 4 consecutively in order to learn the positions of the transponders 1. As this occurs, the wheel house transceiver is actuated first, which adopts the installation position ‘left front wheel’. The subsequently received transponder signal is allocated to the installation position ‘left front wheel’. Thereafter, an identification code can also be written into the transponder that this transponder adopts the installation position ‘left front wheel’. This identification code may be a numerical code. This numerical code can be attached by the transponders in the further data transmission, with the result that an allocation of the supplied tire information to an installation position is given at any time.

When tire information is transmitted in the form of data signals from the wheel house transceivers 4 to the control unit 6 or to the central box 10, respectively, by means of modulation onto existing wheel speed sensor conduits 3, 11, the use of transmitters allows recuperating these modulated data signals. One transmitter per wheel speed sensor conduit is required to this end. Thereafter, the output signals of the transmitters can be connected permanently to a conduit, without omitting the option of the detection of the installation position of the transponders 1. As the control unit 6 or the central box 10, respectively, can specifically address the wheel house transceivers 4, and hence the transponders 1, separately, the data sent from the wheel house transceivers 4 to the control unit 6 or to the central box 10, respectively, can be assigned in a targeted way to an installation position in spite of the transmission on one conduit only. The use of a multiplexer or similar devices, as required in the state of the art, is unnecessary in this case because the transponders 1 emit tire information only after previous energy supply.

In an embodiment of the tire pressure-monitoring system of the invention, the control unit 6 or the central box 10, respectively, includes another input for a transponder antenna, which can evaluate and/or also optionally describe e.g. a transponder integrated in the ignition key or in a module (e.g. an identification card) serving as an ignition key substitute.

The electronic actuating unit for actuating the transmitting antenna 20, 21 of the wheel house transceiver 4 can comprise a conventional oscillation circuit. However, depending on the power requirement, it is advisable to operate the transmitting antenna by means of an H-bridge control, with the result that there is practically no need for build-up periods until the transmitting power is reached, and wherein the specification of the exact frequency including the switch-off point of time allows coupling in data, e.g. by amplitude modulation (ASK), in a temporally exact and very quick manner. The transmitting antenna 20, 21 can be configured as a flatly wound air-core coil (‘flat antenna’) which is inserted into a housing 22, 29, e.g. made of plastics. This housing 22, 29 can additionally comprise the electronic actuating unit and the receiving antenna for receiving the data sent from the transponders 1. The transmitting antenna 20, 21, the electronic actuating unit, and the receiving antenna can also be integrated jointly with other components directly in the housing 22, 29 of the wheel house transceiver 4. To protect the components, the housings 22, 29 are packaged, for example by a friction welding method connecting a housing bottom part 29 of a two-part housing 22, 29 with a housing top part 22. The magnetic field of the antenna is utilized for the energy transfer in the transmitting antenna 20, 21. The contacting of the transmitting antenna 20, 21 and/or of connecting conduits can be carried out e.g. by means of insulation displacement contacts. For a plug connection, e.g. between the housing 22, 29 of the transmitting antenna 20, 21 or the transceivers 4, respectively, press-in technology is used for the purpose of contacting.

Further, a learning phase can be performed to detect the relative position of the transponder 1 in relation to the associated wheel house transceiver 4. As a certain distance between the transponder 1 and the wheel house transceiver 4 must not be exceeded for the transmission of data in the transponder technology, only a certain range of transmission A can be used for transmitting data between the transponder 1 and the wheel house transceiver 4 when a transponder 1 is mounted in or at a tire. When the wheel house transceiver 4 receives data from the transponder 1, a counter allocated to the associated wheel speed sensor 2 can be read or reset at this point of time, whereby the position of the transponder 1 relative to the wheel rotation is known. For example, the wheel speed sensor 2 has a number of edges of 42 edges per wheel rotation. When data is received from the transponder 1, the number of edges of the wheel speed sensor 2 is also counted. The edge 23 is determined, for example, when the transponder data is received. The information about the position of the transponder 1 relative to the wheel speed sensor 2 is determined by the control unit 6 or the central box 10, respectively. In the following, only the capacity or data transmission from the wheel house transceiver 4 into the transponder 1 is carried out when the transponder 1 is proximate the wheel house transceiver 4, meaning close to the edge 23 of the wheel speed sensor 2 in the example. It is also possible to define a range, for example five edges before the edge 23 and give edge after the edge 23, in which the wheel house transceiver 4 is transmitting due to being actuated by the control unit 6. This position indication of the transponder 1 allows drastically reducing the current consumption compared to conventional transponder solutions. The information about the relative position can also be stored by way of an ignition run of the vehicle so that this information will be available again immediately even after the ignition is re-started.

In addition, the wheel speed sensors 2 can be evaluated with respect to whether the individual wheels encounter an excessive wheel slip, which can be due to tire pressure loss. The information about the wheel slip can e.g. also be polled directly from the vehicle data bus or from the brake control unit. In the absence of excessive wheel slip, the evaluation of data sent by the transponders 1 can be reduced, what can be realized by a more rare actuation of the wheel house transceiver 4 by the control unit 6 or the central box 10, respectively.

The tire information sent from the transponders 1 through the wheel house transceivers 4 to the control unit 6 or the central box 10, respectively, can be indicated to the driver by a warning lamp or a display.

When tires are used that have emergency running properties (‘run flat tires’), and it is detected that the tire is running in an emergency, this fact can be indicated to the driver, or this information can be submitted to other systems as well, in order to limit the maximum possible speed of the vehicle by an intervention into the engine electronics, for example. Monitoring the run flat tires and e.g. limiting the maximum speed in the event of a defect at the spare wheels allows that the run flat tires utilized are weaker dimensioned, what saves costs and weight with respect to the tires.

The transponder 1 used comprises a transducer which procures energy and more particularly data from electric or magnetic waves, at least one sensor for detecting tire information, and one transmitter for transmitting tire information. Besides, at least one data memory is provided in the transponder 1 for storing tire information and/or other data. For example, data such as the date of manufacture of the tire, the running performance of the tire (by way of interrogating the kilometer reading), possible tire damages, or driving with too low inflation pressure can be stored in the transponders 1, which data can be read in a repair shop, for example.

The data stored in the transponders 1 and/or the data (tire inflation pressure, temperature, etc.) detected by the transponders 1 can also be transmitted to external receivers e.g. by means of telemetry.

The wheel speed sensor conduits 3, 11, 12 are suitably configured as twisted cables. When a control unit 6 is used, the wheel speed sensor and control conduits 5 can also be designed as twisted cables. Further, the supply line 7 can be led to the wheel house transceivers 4 either together with the wheel speed sensor and control conduits 5 or separated from these.

1-11. (canceled)

12. A tire pressure-monitoring device for a motor vehicle comprising:
transponders (1) which are arranged in or at wheels or tires and communicate with respectively an associated wheel house transceiver (4) via a wireless unidirectional or bi-directional information and energy transmission;
at least one control unit (6) connected to the wheel house transceivers (4) arranged in the area of the wheel houses by way of wheel speed sensor and control conduits (5).

13. A tire pressure-monitoring device according to claim 12, wherein the wheel house transceivers (4) are connected to wheel speed sensors (2).

14. A tire pressure-monitoring device according to claim 12, wherein the control unit (6) uses the wheel speed sensor and control conduits (5) or the wheel speed sensor control conduits (11) to transmit data from and to the wheel house transceivers (4).

15. A tire pressure-monitoring device according to claim 12, wherein the wheel house transceivers (4) respectively comprise at least one transmitting antenna (20, 21) with an electronic actuating unit for transmitting energy and/or data to the associated transponder (1), and one receiving antenna with amplifying circuit for receiving and amplifying the tire information sent by the associated transponder (1).

16. A tire pressure-monitoring device according to claim 15, wherein at least one transmitting antenna (20, 21) of the wheel house transceiver (4) includes a H-bridge control for transmitting energy or data.

17. A tire pressure-monitoring device according to claim 16, wherein the at least one transmitting antenna (20, 21) for the energy transmission to the transponder (1) comprises at least one coil (23).

18. A tire pressure-monitoring device according to claim 16, wherein the transmitting antenna (20, 21) for the energy transmission to the transponder (1) comprises at least one coil (23) with a ferrite core or a ferromagnetic core, which leads the magnetic flux for better conduction to the transponder (1).

19. A tire pressure-monitoring device according to claim 16, wherein the transmitting antenna (20, 21) for the energy transmission to the transponder (1), in addition to at least one coil (23) for the energy transmission to the transponder (1), comprises further coils to enhance the efficiency by directing the magnetic flux through the transponder (1).

20. A tire pressure-monitoring device according to claim 12, wherein the control unit (6) interchanges data with other systems in the vehicle through a data line (17).

21. A tire pressure-monitoring device according to claim 12, wherein the control unit (6) or the central box (10) includes at least one connecting conduit (18) and at least one additional actuating conduit (19) to actuate an additional transponder.

22. A tire pressure-monitoring device according to claim 21, wherein the additional transponder is integrated into an ignition key or into a subassembly suitable to start the vehicle or to deactivate an immobilizer.
